(19) United States
(12) Patent Application Publication
(10) Pub. No.: US 2002/0114159 A1
(43) Pub. Date: Aug. 22, 2002

(54) Christmas decorative light bulb string

(76) Inventor: Wun Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/789,604

(22) Filed: Feb. 22, 2001

(51) Int. Cl. F21W 121/00

(52) U.S. Cl. 362/252; 362/227; 362/806

(57) ABSTRACT

The present invention relates to a Christmas decorative light bulb string, which mainly includes a main connecting electrical wire with several branch strings being connected in parallel. Each branch string is performed to be a continuous arched structure having different arched degree for obtaining an administrative decorative level and providing a novel utilized lighting effect.

### BACKGROUND OF THE INVENTION

It is popular to use a Christmas light bulb string being assembled to be a particular structure for a different decorative effect. A conventional light bulb string provides a main electrical wire connecting with a series bulb string, which is formed to be a continuous arched outlook by hanging around the string. This known structure is performed with a single series bulb string, which must have a large number of the bulb assembly. So the high voltage and currency will be necessary for providing an enough lighting effect. Furthermore, the series bulb string could not be used if any bulb assembly is broken accidentally.

Accordingly, the primary object of the invention is to provide a novel Christmas decorative light bulb string, which has provided with several bulb strings connected in parallel to increase the utility and shining effect. Now the features and advantages of the present invention will be described in detail with reference to the accompanying drawings.

### BRIEF DESCRIPTION OF ACCOMPANYING DRAWINGS

FIG. 1 is a plan view showing an exemplary Christmas decorative light bulb string according to the present invention.

FIG. 2 is a plan view of FIG. 1 connected with a controller according to the present invention.

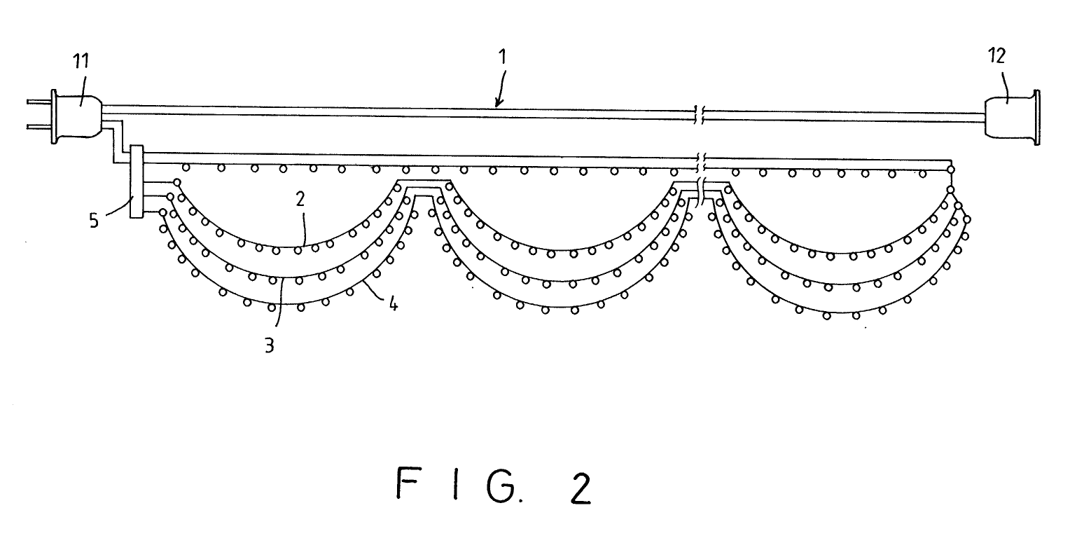

### DETAILED DESCRIPTION OF PREFERRED EMBODIMENTS

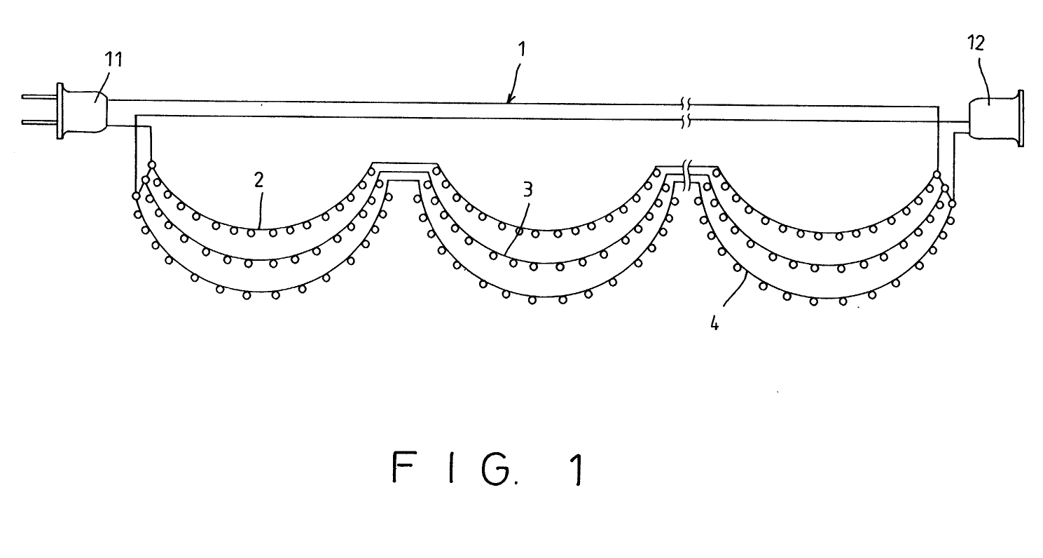

Referring to FIG. 1, the present invention is to provide an improved Christmas decorative light bulb string, which includes a main connecting electrical wire (1) having one end connected with a plug (11) and another end with a tail socket (12). The improvement of this invention is to provide with several branch strings connected in parallel, which are extended from the main electrical wire (1). For example in this embodiment, it includes a first string (2), a second string (3), and a third string (4), wherein each string is performed to be a continuous arched structure with different arched degree to become an administrative level. Since the branch string is connected in parallel, it will not affect each other if one is broken and maintains a limited lighting effect. The number of the bulb assembly connected with the branch string can be reduced for easily manufacturing and assembling.

As above mentioned, it is only an exemplary according to the present invention. It can provide with a controller (5) connecting with the parallel branch strings for controlling and varying the lighting effect. Moreover, other simple modification will be claimed in this invention, such as to increase the number of the branch string for shining purpose.

What is claimed is:

1. A Christmas decorative light bulb string including a main connecting electrical wire having one end connected with a plug and the other end with a tail socket; the characteristic is to provide with several branch strings being connected in parallel while each string is performed to be a continuous arched structure with different degree.

2. The Christmas decorative light bulb string as claimed in claim 1, wherein the number of the branch string is two or more than two.

3. The Christmas decorative light bulb string as claimed in claim 1, wherein a controller is provided to connect with the parallel branch strings.
